(19) United States
(12) Patent Application Publication
(10) Pub. No.: US 2016/0005433 A1
(43) Pub. Date: Jan. 7, 2016

(54) APPLICATION FOR ENHANCING A MULTIMEDIA USAGE ON AN ELECTRONIC DEVICE

(71) Applicant: Oaluwaseun Adedeji, Airway Heights, WA (US)

(72) Inventor: Oaluwaseun Adedeji, Airway Heights, WA (US)

(21) Appl. No.: 14/739,348

(22) Filed: Jun. 15, 2015

Related U.S. Application Data
(60) Provisional application No. 62/021,508, filed on Jul. 7, 2014.

(51) Int. Cl. G11B 20/10

(52) U.S. Cl. CPC G11B 20/10527

(57) ABSTRACT

The present invention relates to implementing an application that enhances the multimedia usage by allowing the consumer to record a video seamlessly without interrupting the streaming of an audio file that is played either in the foreground or in the background on an electronic device. Further, the application allows the user to synchronize the recorded video file with an audio file and merge a plurality video files that are recorded. Furthermore, the application can be used to monitor the speed of the video file that is streamed on the electronic device.

### FIELD OF THE INVENTION

The present invention generally relates to enhancing a multimedia usage on an electronic device and more particularly relates to implementing an application that enhances the multimedia usage by allowing a user to record video seamlessly without interrupting an audio file that is being played either in the foreground or in the background on the electronic device.

### BACKGROUND OF THE INVENTION

Multimedia applications are used extensively to capture live events. Currently, various types of multimedia applications are supported on the electronic devices to record audio, video, animation, and music files. However, the existing multimedia applications do not provide benefits to the multimedia user by facilitating the user to upload various multimedia formats at the same time, monitoring the speed of the video stream that is rendered on the electronic device, facilitating interoperability and compatibility related aspects for the user while the user is expected to handle various multimedia applications and formats, and/or allowing the user to record a video file without interrupting the audio file that is being played on the electronic device.

Hence, there is a need for an application that can enhance the multimedia usage for the user by providing additional benefits to the user while using the multimedia application.

### SUMMARY OF THE INVENTION

The present invention relates to implementing an application for enhancing a multimedia usage on an electronic device, wherein the application enhances the multimedia usage by allowing a consumer to seamlessly record a video while an audio file is being played either in the foreground or in the background and without interrupting the streaming of the audio file. Further, the application provides a means to synchronize the audio file being played with the video file that is being recorded and a means to merge a plurality of video files that are recorded, which can be rendered as a slide-show. Further, the application provides a means to monitor the speed of video stream that is rendered on the electronic device.

### BRIEF DESCRIPTION OF DRAWINGS

FIG. 1 illustrates a screen-shot of the application 101 that is installed on an electronic device 100.

FIG. 2 illustrates a screen-shot of the application 101 loading the required files on the electronic device 100.

FIG. 3 illustrates a screen-shot of the application 101 that depicts the speed of the video file that is streamed on the electronic device 100.

FIG. 4 illustrates a screen-shot of the application 101 for facilitating interoperability with various social networking platforms.

FIG. 5 illustrates a screen-shot for setting-up the application 101.

FIG. 6 illustrates a screen-shot of the application 101 that depicts the recording and merging of one or more video files.

FIG. 7 illustrates a screen-shot of the application 101 that depicts the text file being streamed to the application 101 from other social networking platform.

FIG. 8 illustrates a screen-shot of the application 101 that records the video file while an audio file is being played on the electronic device 100.

### FIGURE DESCRIPTION

100—An electronic device

101—An application installed on the electronic device to enhance the multimedia usage.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, an electronic device refers to a device on which an application 101 can be installed and used for enhancing the multimedia usage. For example, the electronic device 100 can be a mobile device, a smart phone, a laptop, a tablet, a personal computer, or the like.

Throughout the document, the terms consumer and/or user refers to the person who has registered with the application 101 that enhances the multimedia usage on the electronic device 100.

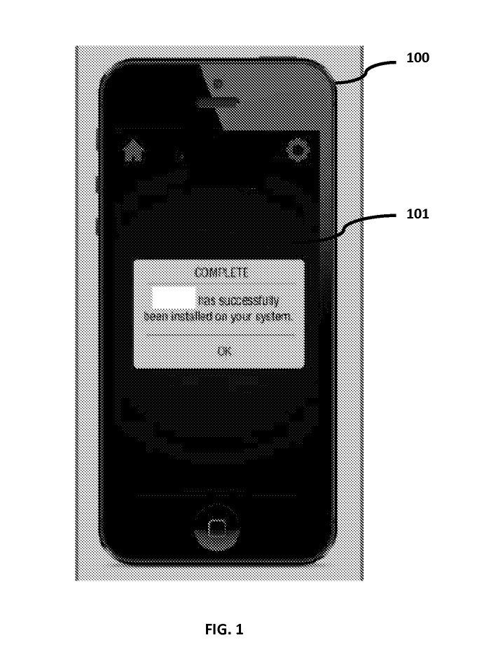

Referring to FIG. 1 illustrates a screen-shot of the application 101 that is installed on the electronic device 100. The application installed on the electronic device 100 provides or facilitates the following benefits to the consumers: allows the user to upload music files and video files simultaneously, gives the user the ability to monitor the speed of video files being streamed on the electronic device 100, allows social media avenues to be compatible with the application 101, and gives the user the ability to merge the audio and video files that are streamed through various multimedia applications. The application also allows the user to play music either in the foreground or in the background and record the video simultaneously, and provides an option to string together multiple videos for making a slideshow.

In an embodiment, the application allows the user to multitask on the electronic device while recording the video file. For example, the user can attend to a phone call while he/she is recording the video file and is listening to the music file that is running in the foreground or background. In the proposed invention, the term video file refers to the digital video data.

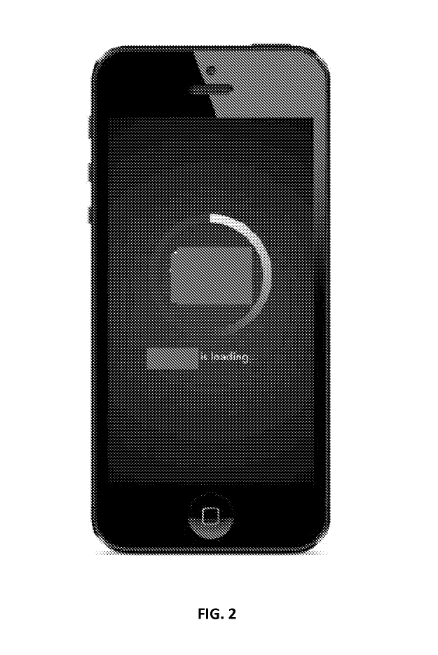

Referring to FIG. 2 illustrates a screen-shot of the application 101 loading the required files on the electronic device 100.

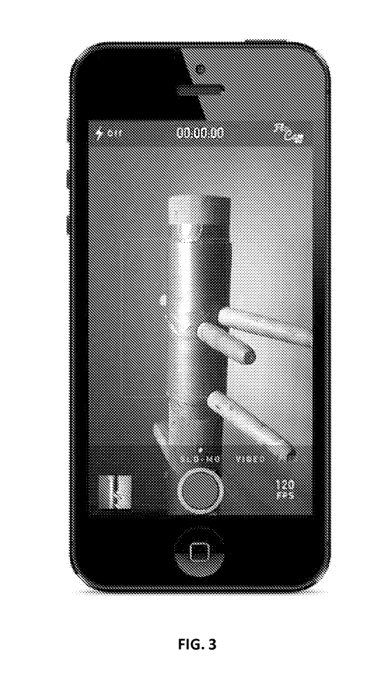

Referring to FIG. 3 illustrates a screen-shot of the application 101 that depicts the speed of the video file that is streamed on the electronic device 100. In an embodiment, as the video file is streamed on the electronic device 100, the application 101 can be configured to determine the rate at which the video frames are rendered on the electronic device 100. As depicted in the screen-shot, the application 101 determines that the rate at which the video frames are rendered is ˜120 frames per second (FPS).

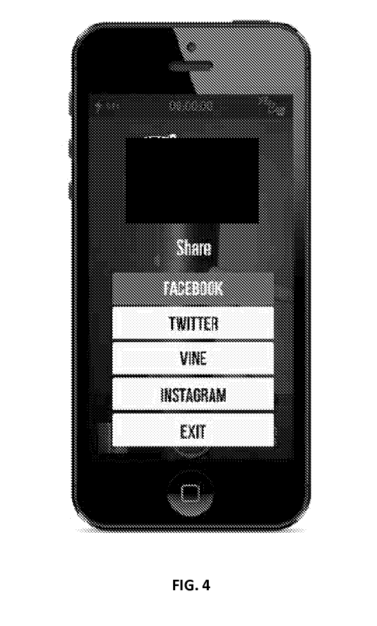

Referring to FIG. 4 illustrates a screen-shot of the application 101 for facilitating interoperability with various social networking platforms. In an embodiment, the application 101 facilitates interoperability with various social networking platforms such as Facebook, Twitter, Vine, Instagram, or the like and shares different file formats across these platforms to provide additional services, such as synchronizing the files, merging the shared files, uploading various files simultaneously, or the like. Additionally, the application 101 supports data compatibility across various social networking platforms. For example, the text file that is shared by the Facebook platform can be merged with an audio file shared through Twitter by using the application 101 and the merged files can be rendered on the Instagram platform or any other platform connected within the network. For example, while delivering a training session through the social networking platform, the text version of the training material or the presentation slide-set rendered through the application 101 can be associated with an audio file, wherein the audio file can be streamed from another social networking platform such as an “Instagram platform”.

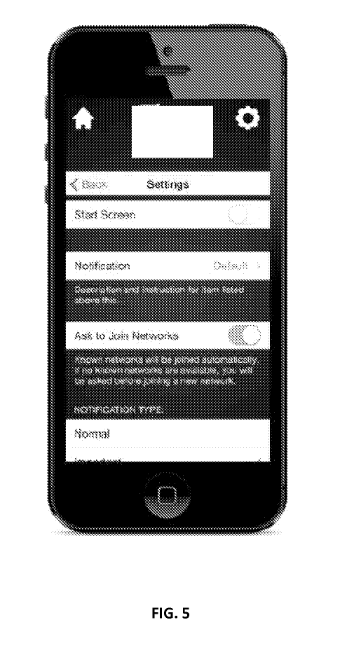

Referring to FIG. 5 illustrates a screen-shot for setting-up the application 101. In an embodiment, the application 101 settings can be configured by the user for viewing the application user interface, receiving specific type of notification, listing various social networking platforms that are connected to the network, or the like. Based on the application 101 settings configured by the user, the consumer can view the multimedia files and/or the messages on the electronic device 100.

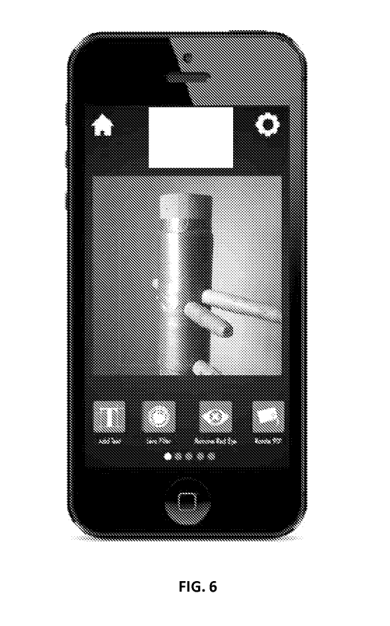

Referring to FIG. 6 illustrates a screen-shot of the application 101 that depicts the recording of the video file. The application 101 is initialized to record the video file on the electronic device 100. In an embodiment, the application 101 continue to record the video file seamlessly even when other multimedia applications are executed either in the foreground or in the background on the electronic device 100. For example, the Windows media player that is executed on the electronic device 100 continues to play songs without interrupting the video file recording initiated by the application 101.

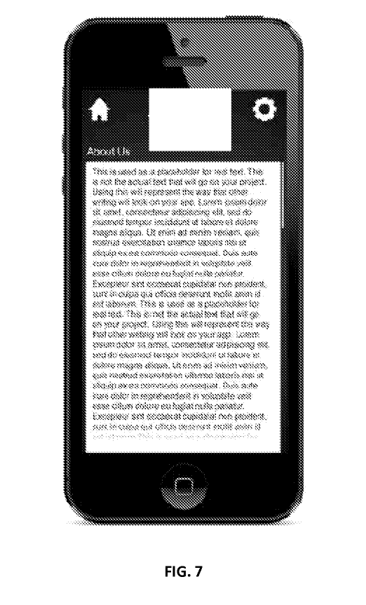

Referring to FIG. 7 illustrates a screen-shot of the application 101 that depicts the text file being streamed to the application 101 from the social networking platform. In an embodiment, the application 101 facilitates compatibility of content shared from various platforms. For example, the text file that is streamed from the Facebook platform is displayed by the application 101. Further, an audio file that is associated with the text file and streamed from an audio player, such as a Windows media player, can also be played by the application 101. For example, while involved in an online discussion through a social networking platform, an audio file that instructs the user to use the online discussion tool assists the user in making the online discussion forum more interesting and interactive. The audio file can be played by the application 101 while the online discussion is in progress.

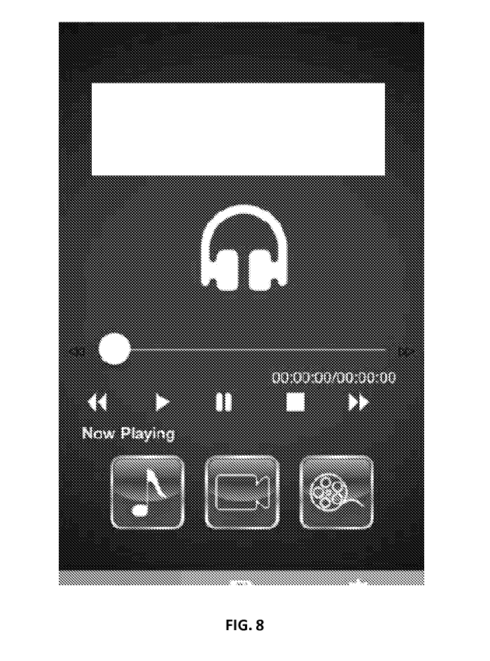

Referring to FIG. 8 illustrates a screen-shot of the application 101 that records the video file while an audio file is being played on the electronic device 100. As depicted in the figure, the application 101 can record the video while an audio file is being played by the application. In an embodiment, recording of the video file can be initiated by performing a gesture on the touch screen of the electronic device. For example, the consumer can perform a single tap gesture, a double tap gesture, a swipe gesture or the like to initiate recording of the video file while an audio file is being played either in the foreground or in the background by an audio player application. In another embodiment, recording of the video file can be initiated by performing a user interface activity that is supported by the application 101. The user interface activity includes but not limited to a button press activity, moving a slide to initiate the recording of the video file while an audio file is being played by an audio player.

1. An application used to enhance a multimedia usage on an electronic device, wherein said application comprises of:
a means to seamlessly record a video while an audio file is being played without interrupting the streaming of said audio file;
a means to synchronize said audio file being played either in the foreground or in the background with said video file that is being recorded;
a means to merge a plurality of video files that are recorded;
a means to monitor the speed of streaming said video that is recorded; and
a means to multitask while recording said video.

2. The application as claimed in claim 1, wherein said audio file being played can be streamed by using any of the existing audio player application that is available on said electronic device.

3. The application as claimed in claim 1, wherein said means to record said video can be initiated by: performing a gesture, performing at least one activity on said application user interface.

4. The application as claimed in claim 3, wherein said at least one activity that can be performed on said application user interface to initiate said video recording includes but not limited to a button press, a slide movement, a mouse click.

5. The application as claimed in claim 3, wherein initiating said video recording by performing a gesture comprises of a single tap, a double tap, a swipe, a hover gesture recognized on said application touch screen.

6. The application as claimed in claim 1, wherein said means to synchronize said audio file being played while recording said video comprises of syncing said audio file that is streamed from various audio player applications with said video recording.

7. The application as claimed in claim 1, wherein synchronizing said audio file being played while recording said video and merging said plurality of video files requires said application to be compatible with various social networking platforms and multimedia applications.

8. The application as claimed in claim 1, wherein said means to multitask while recording said video comprises of allowing a user to perform additional activities through said electronic device without interrupting said video recording.

9. A computer program product comprising computer executable program code recorded on a computer readable non-transitory storage medium, said computer executable program code when executed, causing the actions including:
recording a video seamlessly while an audio file is being played without interrupting the streaming of said audio file;
synchronizing said audio file being played either in the foreground or in the background with said video file that is being recorded;
merging a plurality of video files that are recorded;
monitoring the speed of streaming said video that is recorded; and
allowing a user to multitask while said video file is being recorded.

10. The computer program product as claimed in claim 8, wherein said audio file being played can be streamed by using any of the existing audio player application that is available on said electronic device.

11. The computer program product as claimed in claim 8, wherein recording said video can be initiated by: performing a gesture, performing at least one activity on said application user interface.

12. The computer program product as claimed in claim 10, wherein said at least one activity that can be performed on said application user interface to initiate said video recording includes but not limited to a button press, a slide movement, a mouse click.

13. The computer program product as claimed in claim 10, wherein initiating said video recording by performing a gesture comprises of a single tap, a double tap, a swipe, a hover gesture recognized on said application touch screen.

14. The computer program product as claimed in claim 8, wherein synchronizing said audio file being played while recording said video comprises of syncing said audio file that is streamed from various audio player applications with said video recording.

15. The computer program product as claimed in claim 8, wherein synchronizing said audio file being played while recording said video and merging said plurality of video files requires said application to be compatible with various social networking platforms and multimedia applications.

16. The computer program product as claimed in claim 8, wherein multitasking while recording said video comprises of allowing said user to perform additional activities through said electronic device without interrupting said video recording.
